(19) United States
(12) Patent Application Publication
(10) Pub. No.: US 2025/0050913 A1
(43) Pub. Date: Feb. 13, 2025

(54) VEHICLE ULTRASONIC SENSORS

(71) Applicant: TuSimple, Inc., SAN DIEGO, CA (US)

(72) Inventors: Zhe CHEN, San Diego, CA (US); Lingting GE, San Diego, CA (US); Joshua Miguel RODRIGUEZ, Tucson, AZ (US); Ji HAN, Lake Stevens, WA (US); Panqu WANG, San Diego, CA (US); Junjun XIN, San Diego, CA (US); Xiaoling HAN, San Diego, CA (US); Yizhe ZHAO, San Diego, CA (US)

(21) Appl. No.: 18/486,809

(22) Filed: Oct. 13, 2023

Related U.S. Application Data
(60) Provisional application No. 63/519,208, filed on Aug. 11, 2023.

(51) Int. Cl. B60W 60/00

(52) U.S. Cl. CPC B60W 60/0018; B60W 2420/54; B60W 2554/4049

(57) ABSTRACT

Techniques are described for operating a vehicle using sensor data provided by one or more ultrasonic sensors located on or in the vehicle. An example method includes receiving, by a computer located in a vehicle, data from an ultrasonic sensor located on the vehicle, where the data includes a first set of coordinates of two points associated with a location where an object is detected by the ultrasonic sensor; determining a second set of coordinates associated with a point in between the two points; performing a first determination that the second set of coordinates is associated with a lane or a road on which the vehicle is operating; performing a second determination that the object is movable; and sending, in response to the first determination and the second determination, a message that causes the vehicle to perform a driving related operation while the vehicle is operating on the road.

### CROSS-REFERENCE TO RELATED APPLICATIONS

This application claims priority to and the benefit of U.S. Provisional Application No. 63/519,208, filed on Aug. 11, 2023. The aforementioned application is incorporated herein by reference in its entirety.

### TECHNICAL FIELD

This document relates to systems, apparatus, and methods to equip a vehicle with ultrasonic sensors and/or to use the ultrasonic sensors on or in the vehicle

### BACKGROUND

Autonomous vehicle navigation is a technology that can allow an autonomous vehicle to use images obtained by cameras on the vehicle to determine the position and movement of vehicles around the autonomous vehicle. The autonomous vehicle can safely navigate towards a destination based on the information about the position and movement of the vehicles around the autonomous vehicle. An autonomous vehicle may operate in several modes. In some cases, an autonomous vehicle may allow a driver to operate the autonomous vehicle as a conventional vehicle by controlling the steering, throttle, clutch, gear shifter, and/or other devices. In other cases, a driver may engage the autonomous vehicle navigation technology to allow the vehicle to be driven by itself.

### SUMMARY

A vehicle can include a plurality of ultrasonic sensors that can facilitate driving related operations on the vehicle. This patent document describes systems, apparatus, and methods to equip a vehicle with ultrasonic sensors and/or to use the ultrasonic sensors on or in the vehicle.

An example vehicle operation method includes receiving, by a computer located in a vehicle, data from an ultrasonic sensor located on the vehicle, where the data includes a first set of coordinates of two points associated with a location where an object is detected by the ultrasonic sensor; determining a second set of coordinates associated with a point in between the two points; performing a first determination that the second set of coordinates is associated with a lane or a road on which the vehicle is operating; performing a second determination that the object is movable; and sending, in response to the first determination and the second determination, a message that causes the vehicle to perform a driving related operation while the vehicle is operating on the road.

In some embodiments, the method further includes sending, in response to the first determination and the second determination, another message that causes the vehicle to not perform another driving related operation while the vehicle is stopped on the road. In some embodiments, the another driving related operation includes causing the vehicle to not apply throttle or causing the vehicle to keep brakes applied. In some embodiments, the driving related operation includes causing the vehicle to apply brakes or causing the vehicle to steer away from the object. In some embodiments, the two points include two endpoints of a line that extends in between a sensing region of the ultrasonic sensor. In some embodiments, the point is a midpoint in between the two points. In some embodiments, the second set of coordinates includes two-dimensional (2D) world coordinates of the point.

In some embodiments, the data received from the ultrasonic sensor includes an identifier of the ultrasonic sensor and a timestamp when the object is detected by the ultrasonic sensor, and the 2D world coordinates of the point is determined by: determining a third set of coordinates associated with the point in between the two points based on the first set of coordinates of the two points, where the first set of coordinates and the third set of coordinates are associated with a first coordinate system of the ultrasonic sensor; obtaining, based on the identifier of the ultrasonic sensor, a set of pre-determined values that describe a spatial relationship between an inertial measurement unit (IMU) sensor and the ultrasonic sensor; and determining a fourth set of coordinates of the point in a second coordinate system associated with the IMU sensor by combining the third set of coordinates of the point with the set of pre-determined values, where the second set of coordinates associated with the point is determined based on the fourth set of coordinates of the point in the second coordinate system and 3D world coordinates of the IMU sensor at the timestamp when the object is detected.

In some embodiments, the vehicle comprises a plurality of ultrasonic sensors that include the ultrasonic sensor, and at least two ultrasonic sensors located immediately adjacent to each other have overlapping sensing regions. In some embodiments, the vehicle comprises a plurality of ultrasonic sensors that include the ultrasonic sensor, and a total number of the plurality of ultrasonic sensors is based on a size of or a number of blind spot regions close to the vehicle, or a distribution of the blind spot regions around the vehicle. In some embodiments, the vehicle comprises a plurality of ultrasonic sensors that include the ultrasonic sensor, and a sensitivity related to object detection capability of each ultrasonic sensor is independently adjustable. In some embodiments, the sensitivity of the ultrasonic sensor is adjusted based on a second location of the vehicle.

In some embodiments, the second determination is performed in response to the first determination. In some embodiments, the first determination is performed by querying a map database stored on the computer with the second set of coordinates associated with the point in between the two points, and the method further comprises receiving, from the map database, information that indicates that the second set of coordinates are associated with the lane or the road. In some embodiments, the second determination that the object is movable is performed in response to determining that the information does not include additional information related to the second set of coordinates. In some embodiments, the message is sent in response to the first determination, in response to the second determination, and in response to receiving from the ultrasonic sensor a pre-determined number of consecutive frames that include coordinates of a set of points associated with locations where the object is detected.

In some embodiments, the message is sent in response to the first determination, in response to the second determination, and in response to receiving from the ultrasonic sensor a pre-determined number of frames that include coordinates of a set of points associated with locations where the object is detected, where the pre-determined number of frames is within a pre-determined number of consecutive frames. In some embodiments, the vehicle comprises a plurality of ultrasonic sensors that include the ultrasonic sensor, and the method further comprises sending a second message that causes the vehicle to start driving in response to determining an absence of a detection of another object by each of the plurality of ultrasonic sensors.

In yet another exemplary aspect, the above-described method is embodied in a non-transitory computer readable storage medium comprising code that when executed by a processor, causes the processor to perform the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example scenario of a blind spot region close to a vehicle where sensors may not detect an object.

FIG. 2A shows an example configuration of ultrasonic sensors on a vehicle.

FIG. 2B shows an example sensing pattern of ultrasonic sensors on a vehicle.

FIG. 2C shows two examples of objects detected by ultrasonic sensors.

FIG. 3 shows a block diagram of an example vehicle ecosystem in which driving operations can be based on information provided by one or more ultrasonic sensors on or in a vehicle.

FIG. 4 shows an example flowchart for processing information provided by an ultrasonic sensor on a vehicle.

FIG. 5 shows an example flowchart for operation a vehicle using information provided by one or more ultrasonic sensors on the vehicle.

### DETAILED DESCRIPTION

Developments in autonomous driving technology have enabled a vehicle drive safely around an object (e.g., vehicle) located next to the vehicle upon determining a presence and characteristics of the object. A vehicle can be equipped with plurality of cameras, LiDARs, and/or Radars so that these sensors can provide sensor data that can allow a computer located in the vehicle to determine a presence and characteristics of object(s) located around the vehicle. Despite having multiple sensors on or in a vehicle, there may be some blind spots where a sensor may not be able to capture sensor data of a region.

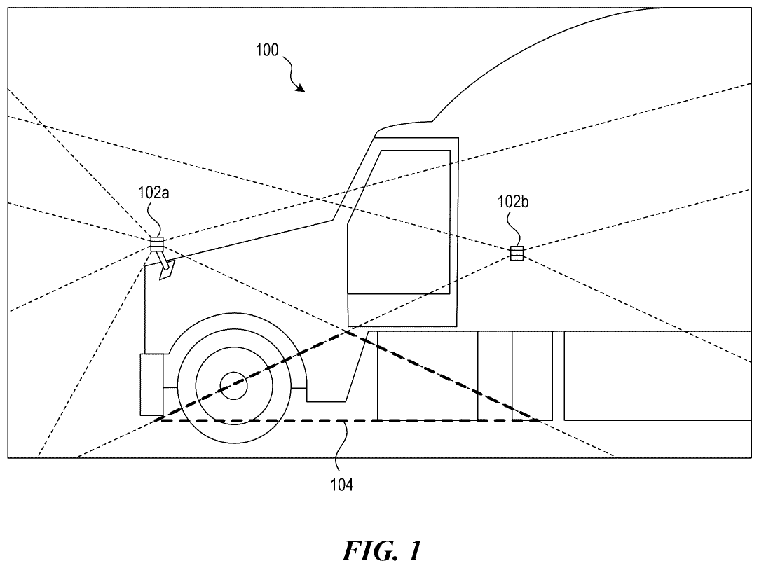

FIG. 1 shows an example scenario of a blind spot region close to a vehicle where sensors may not detect an object. In the example sensor configuration shown in FIG. 1, vehicle 100 includes two LiDARs 102a, 102b that are respectively located in front corner and a side of the vehicle 100. The field-of-views (FOVs) of the LiDARs 102a, 102b are indicated by dashed lines. The FOVs of the two LiDARs 102a, 102b can create a blind spot region 104 that is shown as a triangle. As shown in FIG. 1, the blind spot region 104 can be located close to the side of the vehicle 100, where the blind spot region 104 extends from a region that includes a front bumper and wheel to another region that includes a side of the vehicle 100.

While FIG. 1 shows a single blind spot region 104, there may be other blind spot regions as well. For example, in FIG. 1, a region immediately in front of the front bumper and below the FOV of LiDAR 102a can be another blind spot region. Other sensors such as cameras and/or Radars located on or in a vehicle can also be associated with blind spot regions that can be close to the vehicle. For example, if some cameras are mounted on top of a cab of a tractor unit of a semi-trailer truck and are facing towards a front of the tractor unit, then the cameras may not capture images of a region immediately in front of the front bumper of the tractor unit. To address at least this technical problem with having blind spot region(s), this patent application describes technology to equip and use ultrasonic sensors on or in a vehicle.

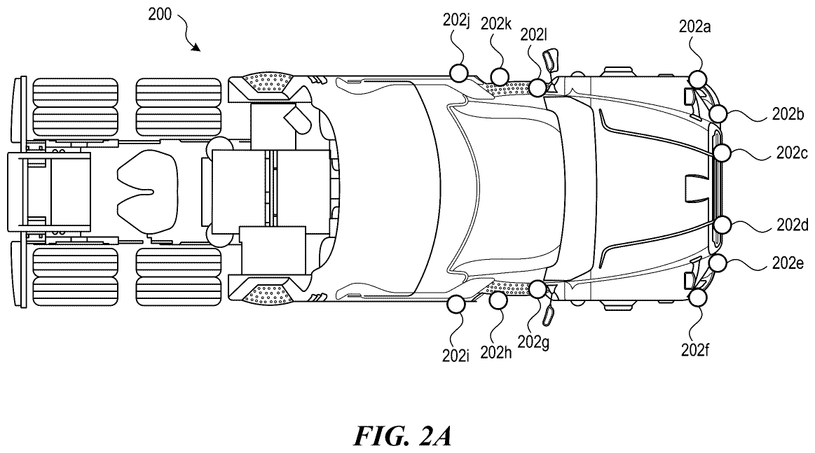

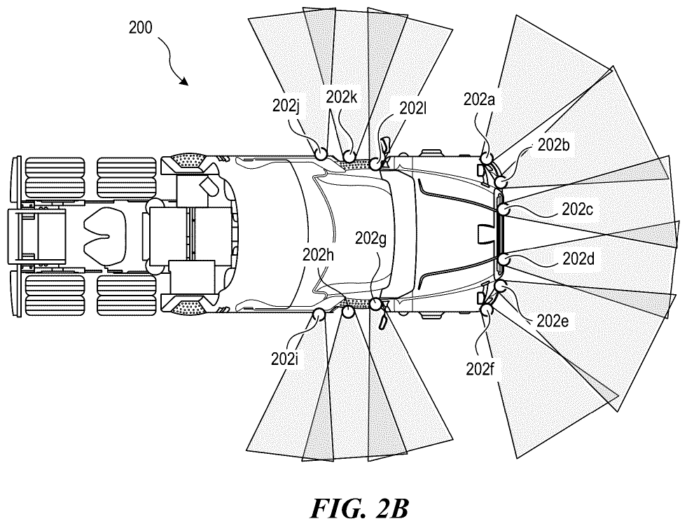

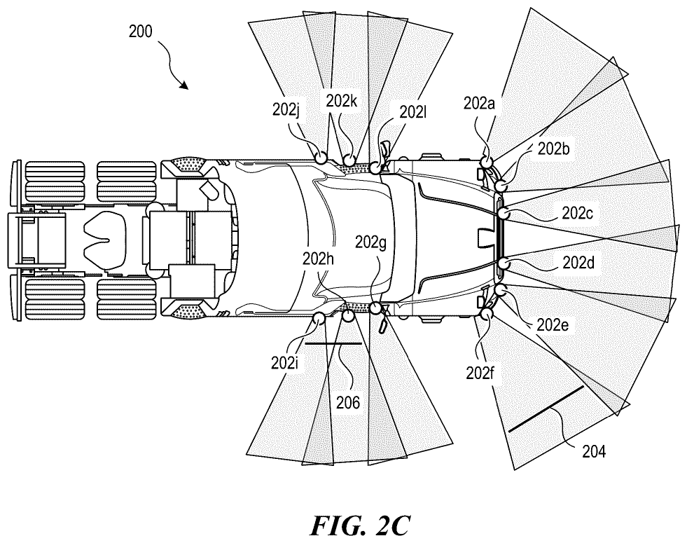

FIG. 2A shows an example configuration of ultrasonic sensors on a vehicle. The vehicle 200 may be a tractor unit of a semi-trailer truck and includes a front bumper. The vehicle 200 may include twelve ultrasonic sensors 202a-2021. Ultrasonic sensors 202a-202f may be installed on a front bumper and may be pointing outward to sense regions in front of the vehicle 200 and to the front-left and front-right of the vehicle 200. Ultrasonic sensors 202g-202i may be installed on a first side of the vehicle 200, and ultrasonic sensors 202j-2021 may be installed on a second side opposite to the first side of the vehicle 200. The ultrasonic sensors 202a-2021 may be arranged into a plurality of groups or clusters. For example, a first group of ultrasonic sensors may include ultrasonic sensors 202a-202c, a second group of ultrasonic sensors may include ultrasonic sensors 202d-202f, a third group of ultrasonic sensors may include ultrasonic sensors 202g-202i, and a fourth group of ultrasonic sensors may include ultrasonic sensors 202j-2021.

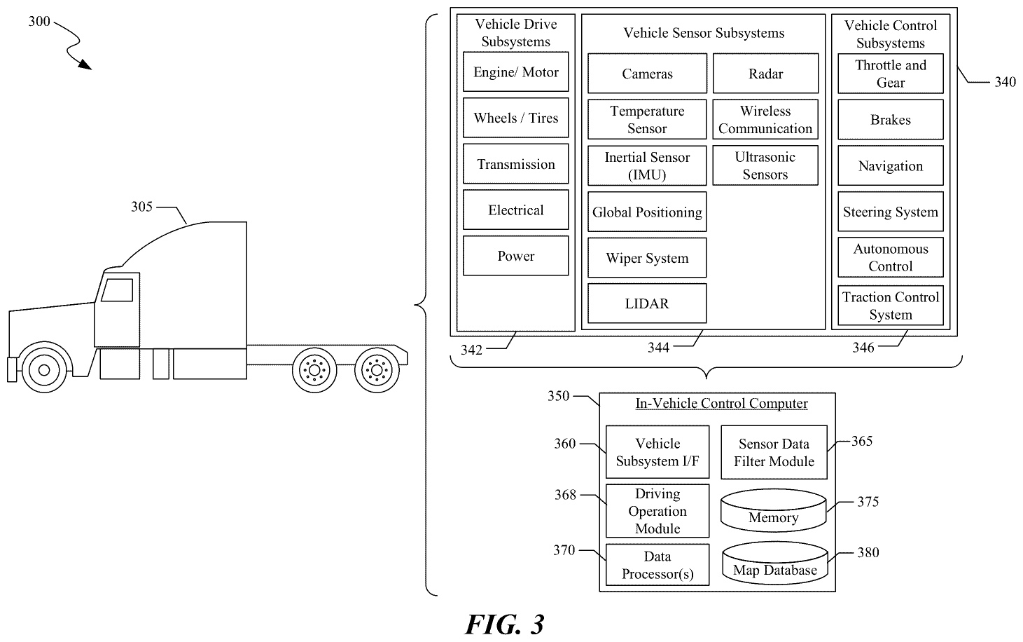

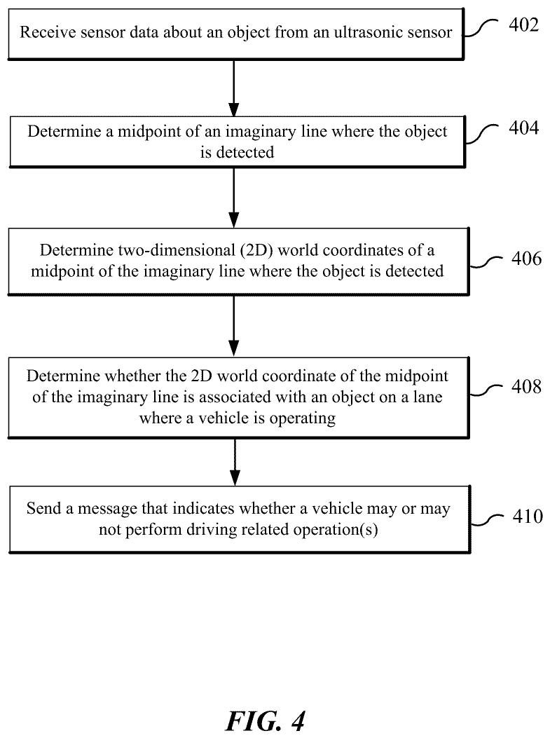

FIG. 2B shows an example sensing pattern of ultrasonic sensors on a vehicle. In FIG. 2B, the vehicle 200 may include twelve ultrasonic sensors 202a-2021 in the same configuration as shown in FIG. 2A. Each ultrasonic sensor is associated with a corresponding sensing region that describes an area within which an ultrasonic sensor can sense or detect an object. In some embodiments, an ultrasonic sensor can provide as an output locations of two endpoints that describe a line where an object is detected. The locations of the two endpoints can be provided by the ultrasonic sensor in a coordinate system specific to the ultrasonic sensor. As further explained in the context of FIG. 4, a sensor data filter module (shown as 365 in FIG. 3) can determine 2D world coordinates or cast-north-up (ENU) coordinates of an object based on the locations of the two endpoints provided by an ultrasonic sensor. In some embodiments, as shown in FIG. 2B, each ultrasonic sensor may have a sensing region that has at least some region that overlaps with another sensing region of another adjacent ultrasonic sensor. Thus, in some embodiments, any two adjacent ultrasonic sensors from ultrasonic sensors 202a-202f may have sensing regions that at least partially overlap, any two adjacent ultrasonic sensors from ultrasonic sensors 202g-202i may have sensing regions that at least partially overlap, and any two adjacent ultrasonic sensors from ultrasonic sensors 202j-2021 may have sensing regions that at least partially overlap.

A technical benefit of arranging or positioning a set of ultrasonic sensors in a group with overlapping sensing regions is that it can beneficially minimize false positives where an object is erroneously detected by one ultrasonic sensor. Another technical benefit of arranging or positioning a set of ultrasonic sensors in a group with overlapping sensing regions is that when at least two ultrasonic sensors detect an object located within their sensing regions, the sensor data filter module can determine 2D world coordinates or GPS coordinates of the object in 2D space using the sensor data (e.g., locations of the two endpoints that describe the line where the object is detected) provided by each of the at least two ultrasonic sensors to the sensor data filter module.

While FIGS. 2A-2B shows twelve ultrasonic sensors 202a-2021 on the vehicle 200, other configurations with fewer or more ultrasonic sensors may be possible. The number of ultrasonic sensors on a vehicle may be based on one or more factors such as a size of or a number of blind spot regions close to the vehicle 200 and/or the distribution of blind spot regions around the vehicle 200.

Ultrasonic sensors 202a-2021 can be used to detect presence of objects that may be located close to the vehicle or within a pre-determined distance from the vehicle. Each ultrasonic sensor 202a-2021 may detect an object up to a pre-determined distance from the location of that ultrasonic sensor. For example, ultrasonic sensor 202c may detect an object located less than or equal to 10 meters from a front bumper of the vehicle 200. The ability of the ultrasonic sensors to detect object(s) in blind spot region(s) located close to the vehicle 200 can be used to improve near range detection of object(s) located near the vehicle 200. The addition of ultrasonic sensors 202a-2021 with other sensors (e.g., cameras, LiDARs, and/or Radars) on the vehicle 200 can also improve robustness for object detection performed a computer in the vehicle 200. Finally, because ultrasonic sensors can improve object detection within short distances from the vehicle (e.g., within 10 meters of a location of an ultrasonic sensor), adding ultrasonic sensors with other sensors (e.g., cameras or LiDAR) on a vehicle can help the computer in the vehicle 200 to detect object that is very close to the vehicle 200 that may not be detected by the other sensors.

FIG. 2C shows two examples of objects detected by ultrasonic sensors. On the bottom of FIG. 2C, a line 204 indicates a location where ultrasonic sensor 202f has detected an object. If, as indicated in FIG. 2C, the ultrasonic sensor 202f detects an object, the ultrasonic sensor 202f may provide to the sensor data filter module locations of the two endpoints that describe the line where the object is detected so that the sensor data filter module can create an imaginary line 204 at a distance where the object is detected. The imaginary line 204 may extend from a first pre-determined location of one end of the sensing region of the ultrasonic sensor 202f to a second pre-determined location of another end of the sensing region of the ultrasonic sensor 202f. On the bottom left of FIG. 2C, another line 206 indicates a location where ultrasonic sensors 202h, 202i have detected another object (e.g., curb). In this example, the ultrasonic sensors 202h, 202i detect the object and locations of the two endpoints that describe the another line where the another object is detected to the sensor data filter module so that the sensor data filter module can create the another imaginary line 206 at a distance where the object is detected.

FIG. 3 shows a block diagram of an example vehicle ecosystem 300 in which driving operations can be based on information provided by one or more ultrasonic sensors on or in a vehicle 305. As shown in FIG. 3, the vehicle 305 may be a semi-trailer truck. The vehicle ecosystem 300 includes several systems and components that can generate and/or deliver one or more sources of information/data and related services to the in-vehicle control computer 350 that may be located in a vehicle 305. The in-vehicle control computer 350 can be in data communication with a plurality of vehicle subsystems 340, all of which can be resident in the vehicle 305. A vehicle subsystem interface 360 is provided to facilitate data communication between the in-vehicle control computer 350 and the plurality of vehicle subsystems 340. In some embodiments, the vehicle subsystem interface 360 can include a controller area network (CAN) controller to communicate with devices in the vehicle subsystems 340.

The vehicle 305 may include various vehicle subsystems that support of the operation of vehicle 305. The vehicle subsystems may include a vehicle drive subsystem 342, a vehicle sensor subsystem 344, and/or a vehicle control subsystem 346. The components or devices of the vehicle drive subsystem 342, the vehicle sensor subsystem 344, and the vehicle control subsystem 346 as shown as examples. In some embodiment, additional components or devices can be added to the various subsystems or one or more components or devices (e.g., LiDAR or Radar shown in FIG. 3) can be removed without affecting the operations related to the ultrasonic sensors described in this patent document. The vehicle drive subsystem 342 may include components operable to provide powered motion for the vehicle 305. In an example embodiment, the vehicle drive subsystem 342 may include an engine or motor, wheels/tires, a transmission, an electrical subsystem, and a power source.

The vehicle sensor subsystem 344 may include a number of sensors configured to sense information about an environment or condition of the vehicle 305. As further explained in this patent document, the sensor data filter module 365 in the in-vehicle control computer 350 can filter sensor data provided by one or more ultrasonic sensors in the vehicle sensor subsystem 344, so that the sensor data filter module 365 to provide information to driving operation module 368 that can allow the driving operation module 368 to perform driving related operations on the vehicle 305. For example, the driving operation module 368 can send instruction(s) to a motor in the steering system to steer the vehicle, or the driving operation module 368 can send instruction(s) to the brake system to apply brakes, or the driving operation module 386 can send instructions to increase throttle and/or switch gears. In some embodiments, as explained in this patent document, the driving operation module 368 can receive a message from the sensor data filter module 365 where the message indicates that the driving operation module 368 is allowed to perform a driving related operation (e.g., start applying throttle) or is not allowed to perform a driving related operation (e.g., to stay stopped in one position). The vehicle sensor subsystem 344 may include one or more cameras or image capture devices, one or more temperature sensors, an inertial measurement unit (IMU), a Global Positioning System (GPS) transceiver, a laser range finder/LIDAR unit, a RADAR unit, one or more ultrasonic sensors, and/or a wireless communication unit (e.g., a cellular communication transceiver). The vehicle sensor subsystem 344 may also include sensors configured to monitor internal systems of the vehicle 305 (e.g., an O₂ monitor, a fuel gauge, an engine oil temperature, etc.,).

The IMU may include any combination of sensors (e.g., accelerometers and gyroscopes) configured to sense position and orientation changes of the vehicle 305 based on inertial acceleration. The GPS transceiver may be any sensor configured to estimate a geographic location of the vehicle 305. For this purpose, the GPS transceiver may include a receiver/transmitter operable to provide information regarding the position of the vehicle 305 with respect to the Earth. The RADAR unit may represent a system that utilizes radio signals to sense objects within the local environment of the vehicle 305. In some embodiments, in addition to sensing the objects, the RADAR unit may additionally be configured to sense the speed and the heading of the objects proximate to the vehicle 305. The laser range finder or LIDAR unit may be any sensor configured to sense objects in the environment in which the vehicle 305 is located using lasers. The cameras may include one or more devices configured to capture a plurality of images of the environment of the vehicle 305. The cameras may be still image cameras or motion video cameras.

The vehicle control subsystem 346 may be configured to control operation of the vehicle 305 and its components. Accordingly, the vehicle control subsystem 346 may include various elements such as a throttle and gear, a brake unit, a navigation unit, a steering system and/or an autonomous control unit. The throttle may be configured to control, for instance, the operating speed of the engine and, in turn, control the speed of the vehicle 305. The gear may be configured to control the gear selection of the transmission. The brake unit can include any combination of mechanisms configured to decelerate the vehicle 305. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 305. The navigation unit may additionally be configured to update the driving path dynamically while the vehicle 305 is in operation. In some embodiments, the navigation unit may be configured to incorporate data from the GPS transceiver and one or more predetermined maps so as to determine the driving path for the vehicle 305. The steering system may represent any combination of mechanisms that may be operable to adjust the heading of vehicle 305 in an autonomous mode or in a driver-controlled mode.

The autonomous control unit may represent a control system configured to identify, evaluate, and avoid or otherwise negotiate potential obstacles in the environment of the vehicle 305. In general, the autonomous control unit may be configured to control the vehicle 305 for operation without a driver or to provide driver assistance in controlling the vehicle 305. In some embodiments, the autonomous control unit may be configured to incorporate data from the GPS transceiver, the RADAR, the LIDAR, the cameras, and/or other vehicle subsystems to determine the driving path or trajectory for the vehicle 305.

The traction control system (TCS) may represent a control system configured to prevent the vehicle 105 from swerving or losing control while on the road. For example, TCS may obtain signals from the IMU and the engine torque value to determine whether it should intervene and send instruction to one or more brakes on the vehicle 305 to mitigate the vehicle 305 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

Many or all of the functions of the vehicle 305 can be controlled by the in-vehicle control computer 350. The in-vehicle control computer 350 may include at least one data processor 370 (which can include at least one microprocessor) that executes processing instructions stored in a non-transitory computer readable medium, such as the data storage device 375 or memory. The in-vehicle control computer 350 may also represent a plurality of computing devices that may serve to control individual components or subsystems of the vehicle 305 in a distributed fashion. In some embodiments, the data storage device 375 may contain processing instructions (e.g., program logic) executable by the data processor 370 to perform various methods and/or functions of the vehicle 305, including those described for the sensor data filter module 365 and the driving operation module 368 as explained in this patent document. For instance, the data processor 370 executes the operations associated with sensor data filter module 365 and/or driving operation module 368 for determining various driving related operations of the vehicle 105 based on the operations performed by sensor data filter module 365.

The data storage device 375 may contain additional instructions as well, including instructions to transmit data to, receive data from, interact with, or control one or more of the vehicle drive subsystem 342, the vehicle sensor subsystem 344, and the vehicle control subsystem 346. The in-vehicle control computer 350 can be configured to include a data processor 370 and a data storage device 375. The in-vehicle control computer 350 may control the function of the vehicle 305 based on inputs received from various vehicle subsystems (e.g., the vehicle drive subsystem 342, the vehicle sensor subsystem 344, and the vehicle control subsystem 346). The in-vehicle control computer 350 may store a map database 380 that may include locations (e.g., 3D coordinates) of stationary objects (e.g., speed bumps, curbs, lanes, etc.) located on a road.

FIG. 4 shows an example flowchart for processing information provided by an ultrasonic sensor on a vehicle. At operation 402, the sensor data filter module in the in-vehicle control computer can receive the following sensor data from an ultrasonic sensor: (1) locations (e.g., coordinates) of two endpoints that describe an imaginary line where an object is detected, (2) a timestamp when the object is detected, and/or (3) an identifier of the ultrasonic sensor. At operation 404, the sensor data filter module can determine a midpoint of an imaginary line that extends from one endpoint to another endpoint based on the locations of the two endpoints provided by the ultrasonic sensor.

At operation 406, the sensor data filter module can determine two-dimensional (2D) world coordinates of a midpoint of the imaginary line where the object is detected. The sensor data filter module can first determine the midpoint of the imaginary line. The sensor data filter module can obtain the coordinates of the midpoint of the imaginary line based on the coordinates of the two endpoints provided by the ultrasonic sensor. Since the coordinates of the midpoint may be in a coordinate system specific to the ultrasonic sensor that provided the coordinates of two endpoints, the sensor data filter module can determine 2D world coordinates (e.g., 2D ENU coordinates) of the midpoint of the imaginary line by performing the following operations: (1) obtain, based on the identifier of the ultrasonic sensor, a set of pre-determined values (e.g., inertial measurement unit (IMU) sensor to ultrasonic sensor extrinsic parameters) that describe a spatial relationship between the IMU sensor and the ultrasonic sensor or that describe a location of the ultrasonic sensor relative to another location of the IMU sensor; (2) combine the coordinates of the midpoint with the set of pre-determined values to determine a first set of coordinates of the midpoint of the imaginary line in IMU coordinate system; and (3) obtain 2D world coordinates of the midpoint of the imaginary line based on the first set of coordinates in IMU coordinate system (e.g., GPS coordinates or 3D world coordinates) of the IMU sensor at the timestamp provided by the ultrasonic sensor when the object is detected.

At operation 408, the sensor data filter module can determine whether the 2D world coordinate of the midpoint of the imaginary line (which is considered the 2D world coordinate of the object) is associated with a lane where the vehicle comprising the in-vehicle control computer is operating. For example, the sensor data filter module can query a map database stored in the in-vehicle control computer with the 2D world coordinate of the midpoint of the imaginary line to obtain information about the object associated with the 2D world coordinate. A map database may provide to the sensor data filter module information that indicates that the 3D world coordinates is located on a lane and may provide additional information about characteristics associated with the 3D world coordinate (e.g., type of object, identifier of the object, etc.). As explained below, the additional information provided the map database can be a beneficial technical feature that can allow the sensor data filter module to efficiently indicate to the driving operation module (shown as 368 in FIG. 3) to perform driving related operations when dynamic objects are detected on a lane/road on which the vehicle may be operating.

If the sensor data filter module determines from the information provided by the map database that the object is located on the road, then the sensor data filter module can process the additional information about the object from the map database. In some embodiments, if the sensor data filter module obtains from the map database additional information that indicates that the object type associated with the 3D world coordinate is, for example, a traffic sign or speed bump, then the sensor data filter module determines that the object detected by the ultrasonic sensor is a stationary object. In some embodiments, the map database itself may provide an indication that the object type associated with the 3D world coordinates is a stationary object. If the sensor data filter module determines that the object is a stationary object (e.g., curb or traffic sign) and that the object is located on a lane in the road as mentioned above, then at operation 410, the sensor data filter module can send a message to a driving operation module that indicates whether a vehicle that comprises the in-vehicle control computer can perform or continue to perform driving related operations. At operation 408, if the sensor data filter module determines that the 2D world coordinates of the object is not located on a lane in the road, then the sensor data filter module can determine and/or allow the vehicle to continue to perform driving related operations.

In some embodiments, if upon querying the map database at operation 408, the map database provides information related to 2D world coordinate of the object and indicates that the object is located on a lane on a road, then the sensor data filter module may create a tag or an entry in a database for the object, where the tag or entry may include the information (e.g., type of object such as traffic sign, identifier of the object, indication of static object, etc.) provided by map database about the object. In some embodiments, the map database may provide a height of the object related to the 2D world coordinate so that the sensor data filter module can determine a type of the object (e.g., a curb) based on the height.

At operation 408, if sensor data filter module determines that the map database does not have additional information related to 2D world coordinate but that the 2D world coordinate is located on a lane on the road, then the sensor data filter module can determine that the object detected by the ultrasonic sensor is a dynamic (e.g., moving) object. If the sensor data filter module determines that the object is a dynamic object, then at operation 410, the sensor data filter module can send a message to a driving operation module that indicates whether a vehicle that comprises the in-vehicle control computer should perform a set of driving related operation (e.g., send instructions to apply brakes to stop or send instructions to motor in steering system to steer away from the object) or whether the vehicle is not allowed to perform a driving related operation (e.g., keep the vehicle that has stopped in a stopped condition).

In some embodiments, if the sensor data filter module determines that the object is a dynamic object, then at operation 410, the sensor data filter module can perform additional operations to determine whether to send the message to the driving operation module that indicates whether the vehicle may or may not perform driving related operation(s). If an ultrasonic sensor detects an object over a certain period of time, the ultrasonic sensor may provide a plurality of frames to the sensor data filter module, where each frame may include locations of two endpoints that describe a line where an object is detected. In some embodiments, if the sensor data filter module determines that a pre-determined number of consecutive frames indicate that an object is detected, then the sensor data filter module can send the message to the driving operation module that indicates whether the vehicle may or may not perform driving related operation(s). In some embodiments, if the sensor data filter module determines that an object is detected in a pre-determined number of frames (e.g., 3 frames) out of a pre-determined number of consecutive frames (e.g., 6 frames), then the sensor data filter module can send the message to the driving operation module that indicates whether the vehicle may or may not perform driving related operation(s).

A technical benefit of querying the map database with the 2D world coordinate of the midpoint of the imaginary line is that it can help the sensor data filter module determine whether the object detected is stationary or dynamic (e.g., moving). If the sensor data filter module determines that the object is stationary, then the sensor data filter module can allow the driving operation module to continue to send instruction to perform driving related operations on the vehicle. But, if the sensor data filter module determines that the object is dynamic, then the sensor data filter module can send a message to the driving operation module, where the message may indicate whether certain driving operations should or should not be performed. A technical benefit of sending the message based on sensor data from multiple frames is that it can minimize the chances of a false positive causing the sensor data filter module to send the message to the data operation module, where the false positive condition occurs when an ultrasonic sensor erroneously indicates an object that does not exists has been detected.

In some embodiments, the sensor data filter module send the message to the driving operation module that indicates that the vehicle should perform driving related operation(s) (e.g., vehicle can start driving operations) upon determining that the plurality of ultrasonic sensors have not detected an object. In some embodiments, the sensor data send the message to the driving operation module that indicates that the vehicle should perform driving related operation(s) (e.g., vehicle can start driving operations) upon determining that the plurality of ultrasonic sensors have detected an object in less than a pre-determined number of frames (e.g., 1 frame) within a pre-determined number of consecutive frames (e.g., 6 frames).

The capability of an ultrasonic sensor to detect an object is based on several factors such as the temperature of the environment where the vehicle is operating and/or sensitivity of the ultrasonic sensor. In some embodiments, the sensor data filter module can independently adjust the sensitivity of each ultrasonic sensor so that the sensor data filter module can adjust the detection capability of an ultrasonic sensor. For example, in some scenarios, the sensor data filter module can reduce the sensitivity of one or more ultrasonic sensors when the sensor data filter module determines, based on a GPS location of a vehicle comprising the in-vehicle control computer, that the vehicle is operating on a road close to a certain type of object (e.g., a curb).

In some embodiments, if at least two ultrasonic sensors detect a same object, each of the at least two ultrasonic sensors can provide locations of two endpoints that describe a line where an object is detected. In such embodiments, the sensor data filter module can determine a location of the object from the locations of the two endpoints.

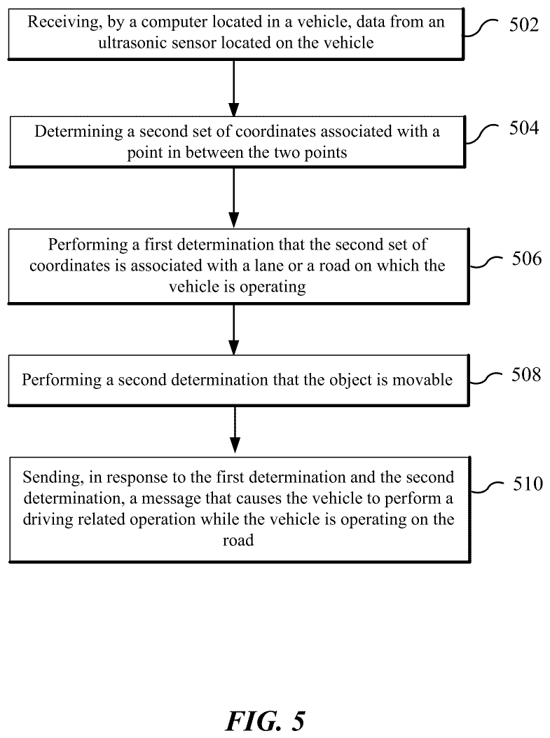

FIG. 5 shows an example flowchart for operation a vehicle using information provided by one or more ultrasonic sensors on the vehicle. Operation 502 includes receiving, by a computer located in a vehicle, data from an ultrasonic sensor located on the vehicle, where the data includes a first set of coordinates of two points associated with a location where an object is detected by the ultrasonic sensor. Operation 504 includes determining a second set of coordinates associated with a point in between the two points. Operation 506 includes performing a first determination that the second set of coordinates is associated with a lane or a road on which the vehicle is operating. Operation 508 includes performing a second determination that the object is movable. Operation 510 includes sending, in response to the first determination and the second determination, a message that causes the vehicle to perform a driving related operation while the vehicle is operating on the road.

In some embodiments, the method further includes sending, in response to the first determination and the second determination, another message that causes the vehicle to not perform another driving related operation while the vehicle is stopped on the road. In some embodiments, the another driving related operation includes causing the vehicle to not apply throttle or causing the vehicle to keep brakes applied. In some embodiments, the driving related operation includes causing the vehicle to apply brakes or causing the vehicle to steer away from the object. In some embodiments, the two points include two endpoints of a line that extends in between a sensing region of the ultrasonic sensor. In some embodiments, the point is a midpoint in between the two points. In some embodiments, the second set of coordinates includes two-dimensional (2D) world coordinates of the point.

In some embodiments, the data received from the ultrasonic sensor includes an identifier of the ultrasonic sensor and a timestamp when the object is detected by the ultrasonic sensor, and the 2D world coordinates of the point is determined by: determining a third set of coordinates associated with the point in between the two points based on the first set of coordinates of the two points, where the first set of coordinates and the third set of coordinates are associated with a first coordinate system of the ultrasonic sensor; obtaining, based on the identifier of the ultrasonic sensor, a set of pre-determined values that describe a spatial relationship between an inertial measurement unit (IMU) sensor and the ultrasonic sensor; and determining a fourth set of coordinates of the point in a second coordinate system associated with the IMU sensor by combining the third set of coordinates of the point with the set of pre-determined values, where the second set of coordinates associated with the point is determined based on the fourth set of coordinates of the point in the second coordinate system and 3D world coordinates of the IMU sensor at the timestamp when the object is detected.

In some embodiments, the vehicle comprises a plurality of ultrasonic sensors that include the ultrasonic sensor, and at least two ultrasonic sensors located immediately adjacent to each other have overlapping sensing regions. In some embodiments, the vehicle comprises a plurality of ultrasonic sensors that include the ultrasonic sensor, and a total number of the plurality of ultrasonic sensors is based on a size of or a number of blind spot regions close to the vehicle, or a distribution of the blind spot regions around the vehicle. In some embodiments, the vehicle comprises a plurality of ultrasonic sensors that include the ultrasonic sensor, and a sensitivity related to object detection capability of each ultrasonic sensor is independently adjustable. In some embodiments, the sensitivity of the ultrasonic sensor is adjusted based on a second location of the vehicle.

In some embodiments, the second determination is performed in response to the first determination. In some embodiments, the first determination is performed by querying a map database stored on the computer with the second set of coordinates associated with the point in between the two points, and the method further comprises receiving, from the map database, information that indicates that the second set of coordinates are associated with the lane or the road. In some embodiments, the second determination that the object is movable is performed in response to determining that the information does not include additional information related to the second set of coordinates. In some embodiments, the message is sent in response to the first determination, in response to the second determination, and in response to receiving from the ultrasonic sensor a pre-determined number of consecutive frames that include coordinates of a set of points associated with locations where the object is detected.

In some embodiments, the message is sent in response to the first determination, in response to the second determination, and in response to receiving from the ultrasonic sensor a pre-determined number of frames that include coordinates of a set of points associated with locations where the object is detected, where the pre-determined number of frames is within a pre-determined number of consecutive frames. In some embodiments, the vehicle comprises a plurality of ultrasonic sensors that include the ultrasonic sensor, and the method further comprises sending a second message that causes the vehicle to start driving in response to determining an absence of a detection of another object by each of the plurality of ultrasonic sensors.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A vehicle operation method, comprising:
receiving, by a computer located in a vehicle, data from an ultrasonic sensor located on the vehicle, wherein the data includes a first set of coordinates of two points associated with a location where an object is detected by the ultrasonic sensor;
determining a second set of coordinates associated with a point in between the two points;
performing a first determination that the second set of coordinates is associated with a lane or a road on which the vehicle is operating;
performing a second determination that the object is movable; and
sending, in response to the first determination and the second determination, a message that causes the vehicle to perform a driving related operation while the vehicle is operating on the road.

2. The vehicle operation method of claim 1, further comprising:
sending, in response to the first determination and the second determination, another message that causes the vehicle to not perform another driving related operation while the vehicle is stopped on the road.

3. The vehicle operation method of claim 2, wherein the another driving related operation includes causing the vehicle to not apply throttle or causing the vehicle to keep brakes applied.

4. The vehicle operation method of claim 1, wherein the driving related operation includes causing the vehicle to apply brakes or causing the vehicle to steer away from the object.

5. The vehicle operation method of claim 1, wherein the two points include two endpoints of a line that extends in between a sensing region of the ultrasonic sensor.

6. The vehicle operation method of claim 1, wherein the point is a midpoint in between the two points.

7. The vehicle operation method of claim 1, wherein the second set of coordinates includes two-dimensional (2D) world coordinates of the point.

8. The vehicle operation method of claim 7,
wherein the data received from the ultrasonic sensor includes an identifier of the ultrasonic sensor and a timestamp when the object is detected by the ultrasonic sensor, and
wherein the 2D world coordinates of the point is determined by:
determining a third set of coordinates associated with the point in between the two points based on the first set of coordinates of the two points, wherein the first set of coordinates and the third set of coordinates are associated with a first coordinate system of the ultrasonic sensor;
obtaining, based on the identifier of the ultrasonic sensor, a set of pre-determined values that describe a spatial relationship between an inertial measurement unit (IMU) sensor and the ultrasonic sensor; and
determining a fourth set of coordinates of the point in a second coordinate system associated with the IMU sensor by combining the third set of coordinates of the point with the set of pre-determined values,
wherein the second set of coordinates associated with the point is determined based on the fourth set of coordinates of the point in the second coordinate system and 3D world coordinates of the IMU sensor at the timestamp when the object is detected.

9. An apparatus for autonomous vehicle operation comprising a processor, configured to implement a method comprising:
receive, by a computer located in a vehicle, data from an ultrasonic sensor located on the vehicle, wherein the data includes a first set of coordinates of two points associated with a location where an object is detected by the ultrasonic sensor;
determine a second set of coordinates associated with a point in between the two points;
perform a first determination that the second set of coordinates is associated with a lane or a road on which the vehicle is operating;
perform a second determination that the object is movable; and
send, in response to the first determination and the second determination, a message that causes the vehicle to perform a driving related operation while the vehicle is operating on the road.

10. The apparatus of claim 9,
wherein the vehicle comprises a plurality of ultrasonic sensors that include the ultrasonic sensor, and
wherein at least two ultrasonic sensors located immediately adjacent to each other have overlapping sensing regions.

11. The apparatus of claim 9,
wherein the vehicle comprises a plurality of ultrasonic sensors that include the ultrasonic sensor, and
wherein a total number of the plurality of ultrasonic sensors is based on a size of or a number of blind spot regions close to the vehicle, or a distribution of the blind spot regions around the vehicle.

12. The apparatus of claim 9,
wherein the vehicle comprises a plurality of ultrasonic sensors that include the ultrasonic sensor, and
wherein a sensitivity related to object detection capability of each ultrasonic sensor is independently adjustable.

13. The apparatus of claim 12, wherein the sensitivity of the ultrasonic sensor is adjusted based on a second location of the vehicle.

14. A non-transitory computer readable program storage medium having code stored thereon, the code, when executed by a processor, causing the processor to implement a method, comprising:
receiving, by a computer located in a vehicle, data from an ultrasonic sensor located on the vehicle, wherein the data includes a first set of coordinates of two points associated with a location where an object is detected by the ultrasonic sensor;
determining a second set of coordinates associated with a point in between the two points;
performing a first determination that the second set of coordinates is associated with a lane or a road on which the vehicle is operating;
performing a second determination that the object is movable; and
sending, in response to the first determination and the second determination, a message that causes the vehicle to perform a driving related operation while the vehicle is operating on the road.

15. The non-transitory computer readable program storage medium of claim 14, wherein the second determination is performed in response to the first determination.

16. The non-transitory computer readable program storage medium of claim 14,
wherein the first determination is performed by querying a map database stored on the computer with the second set of coordinates associated with the point in between the two points, and
wherein the method further comprises:
receiving, from the map database, information that indicates that the second set of coordinates are associated with the lane or the road.

17. The non-transitory computer readable program storage medium of claim 14, wherein the second determination that the object is movable is performed in response to determining that the information does not include additional information related to the second set of coordinates.

18. The non-transitory computer readable program storage medium of claim 14, wherein the message is sent in response to the first determination, in response to the second determination, and in response to receiving from the ultrasonic sensor a pre-determined number of consecutive frames that include coordinates of a set of points associated with locations where the object is detected.

19. The non-transitory computer readable program storage medium of claim 14, wherein the message is sent in response to the first determination, in response to the second determination, and in response to receiving from the ultrasonic sensor a pre-determined number of frames that include coordinates of a set of points associated with locations where the object is detected, wherein the pre-determined number of frames is within a pre-determined number of consecutive frames.

20. The non-transitory computer readable program storage medium of claim 14,
wherein the vehicle comprises a plurality of ultrasonic sensors that include the ultrasonic sensor, and
wherein the method further comprises:
sending a second message that causes the vehicle to start driving in response to determining an absence of a detection of another object by each of the plurality of ultrasonic sensors.
